(19) United States
(12) Patent Application Publication
(10) Pub. No.: US 2008/0224574 A1
(43) Pub. Date: Sep. 18, 2008

(54) STEPPING MOTOR AND STEEL PLATE FOR MANUFACTURING THE STEPPING MOTOR

(76) Inventors: Yuji Enomoto, Hitachi (JP); Yoshihisa Ishikawa, Hitachinaka (JP); Teruyoshi Abe, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/018,848

(22) Filed: Jan. 24, 2008

(30) Foreign Application Priority Data
Mar. 13, 2007 (JP) 2007-062752

(51) Int. Cl. H02K 1/14; H02K 37/12; H02K 15/03; B44C 1/22

(52) U.S. Cl. 310/49 R; 216/22; 310/216

(57) ABSTRACT

A stepping motor comprising:

a stator iron core with a plurality of salient poles each having a small tooth at the tip thereof and stator coils each disposed between the salient poles;

a rotor core with a plurality of teeth in the faces opposite to the stator; and

permanent magnets sandwiched by the rotor cores in an axial direction,

wherein the stator iron core and the rotor core are formed by laminated steel plates. The salient poles of the stator iron cores of the steel plates and small teeth are shaped by etching, and a thickness of the steel plates is 0.05 to 0.30 mm.

### CLAIM OF PRIORITY

The present application claims priority from Japanese application Serial no. 2007-62752, filed on Mar. 13, 2007, the content of which is hereby incorporated by reference into this application.

### FIELD OF THE INVENTION

The present invention relates to a stepping motor and a steel plate for manufacturing the stepping motor.

### RELATED ART

A hybrid type stepping motor is generally utilized in office automation equipments such as printers, robots, or a driving motor for industrial equipments such as transporting apparatuses. Especially, the stepping motors are widely used for precise positioning. In particular, hybrid type stepping motors that utilized magnets and reluctance torque are used for high precision positioning. In order to performing the precise positioning, it is necessary to make a standard step angle small, which is a rotating angle per one pulse input.

In order to make the basic step angle small, it is necessary to design that the number of the teeth (the number of poles) in the circumferential direction is increased. Since the increased number of the poles results in a very small width of small teeth, a gap having a gap size between the stator and the rotor is necessary in accordance with the width. In general, a hybrid type stepping motor having an outer size being 42 mm square or 56 mm square employs a gap of 40 μm to 70 μm.

In order to secure the gap size in production sites a very serious production control has been conducted. At first the steel plates used for the stator and the rotor are selected as electromagnetic steel plates (flat-rolled magnetic steel sheets or strips) having a thickness of 0.5 mm and containing silicon.

The steel plates are punched out into desired shape. In punching the steel plates it is very difficult to punch out the rotor and stator simultaneously from the same area in the same steel plate since the gap size between the rotor and the stator is very small.

Regarding methods for manufacturing iron cores by simultaneous punching out, there are disclosed in Japanese Patent 2006-353001, etc. Because the punching die mechanisms are complicated and of high precision, a sufficient amount of investment for facilities is necessary. Further, since the stator and rotor core manufactured by laminating the punched-out steel plates have scattering in sizes, horning work (polishing) to the inner periphery of the stator and to the outer periphery of the rotor has been conducted to control the gap size as disclosed in Japanese Patent application laid-open 2005-6375. In case where the horning (polishing) work is not employed, the gap size must be controlled to be constant by a special working or processing.

The structure of the hybrid type stepping motor and methods of manufacturing the cores are disclosed in the following patent documents. The documents disclose punching methods using electro-magnetic steel plates having a thickness of about 0.5 mm.
Patent document No. 1: Japanese Patent laid-open11-289737
Patent document No. 2: Japanese Patent laid-open2006-353001
Patent document No. 3: Japanese Patent laid-open2005-06375

In a hybrid type stepping motor for use in high precision positioning performance of the motor greatly depends on size precisions of the stator and small teeth of the rotor. Therefore, horning work of the punched-out laminated stator iron core and rotor core must be applied to thereby secure the size precision. However, the horning work may generate problems such as burrs or metal particles that may stick to the stator and/or rotor to thereby cause clogging in gaps after assembling the motor. This would lower the yielding of the motor production.

There may arise another problem from horning. There arises a size scattering in the inner diameter of the stator or the outer diameter of the rotor that has been subjected to horning. Although frequent replacements of polishing grindstone may relieve the problem to some extent, a production cost may increase, which is not acceptable from the practical points of view.

There is another problem arising from the punching work. The punching work generates a shearing stress to the steel plates, which causes the magnetic properties to be worse and generates iron loss. A hybrid type stepping motor having a large number of poles such as 100 poles or more is driven by pulse current with a high frequency. The iron loss generated by the high frequency magnetic flux is large; therefore, the iron core should be of a low iron loss.

The iron loss includes an eddy current loss and hysteresis loss. The hysteresis loss is caused when magnetic segments of the magnet core change their directions under an alternating current, which depends on an area confined in a hysteresis curve.

On the other hand, the eddy current loss generates in a direction partitioning the flow of the magnetic flux of the electro-magnetic plates; in the hybrid type stepping motor eddy current generating in a high frequency magnetic flux at the tips of the small teeth of the stator and the rotor is great. Therefore, the stator iron core is constituted by laminating the electromagnetic plates to form a magnetic circuit. Thus, the eddy current is reduced. Since the stator iron core has such a complicated structure as having salient poles, the stator iron core is manufactured by punching work at present.

Punching work deforms a crystalline structure in the sheared portions of the steel plates thereby to deteriorate magnetic properties thereof and to increase an area confined in a hysteresis curve, which leads to an increase in an iron loss. Because thick electromagnetic steel plates have a large eddy current loss, efficiency of the hybrid type stepping motor is not good.

In punching work even motors having an outer diameter of 30 to 50 mm needs a high precision. Since the precision of punching work is not good, cogging torque of the motor is not improved.

### SUMMARY OF THE INVENTION

The present invention aims at eliminating the above problems and providing a hybrid type stepping motor with a high efficiency and reduced cogging torque.

The stepping motor according to the present invention comprises:

a stator iron core with a plurality of salient poles each having a small tooth at the tip thereof;

a stator having stator coils each disposed between the salient poles;

a rotor core with a plurality of teeth in the faces opposite to the stator; and

permanent magnets sandwiched between the rotor iron cores in an axial direction,

wherein the stator iron core and the rotor core are made of laminated steel plates, the salient poles of the steel plates and small teeth are prepared by etching, and a thickness of the steel plates is 0.05 to 0.30 mm.

According to the present invention, the iron loss and cogging torque of the stepping motor can be reduced.

### BRIEF DESCRIPTION OF DRAWINGS

FIG. 1 shows a structure of the stepping motor of an embodiment according to the present invention wherein FIG. 1(a) is a partially broken away perspective view of the motor and FIG. 1(b) is a cross sectional view along the line A-O-A in FIG. 1(a).

FIGS. 2A and 2B show structures of the iron core wherein FIG. 2A is a plan view and FIG. 2B is an enlarged view of opposite portions of small teeth.

FIG. 3 shows a relationship between a thickness of electromagnetic plates and iron loss. FIG. 4 shows a relationship between a content of silicon in the electromagnetic plates and iron loss.

FIGS. 5A-5D show various sectional views formed by etching the electromagnetic plates.

FIG. 6 shows a typical sectional view formed by punching work of the electromagnetic plates.

FIG. 7 shows an example of a pattern of the iron cores of the hybrid type stepping motor.

FIG. 8 shows an etched pattern of the iron core of the hybrid type stepping motor.

FIG. 9 shows an example of a method of laminating steel plates that have been subjected to etching.

FIG. 10 shows an example of a method of laminating etched iron cores of the steel plates produced from a single steel plate.

FIGS. 11A-11E show structures of tips of teeth and flow of magnetic flux in a hybrid type stepping motor of the present invention, wherein FIGS. 11A to 11C are plan views and FIGS. 11D to 11E are sectional views.

FIGS. 12A and 12B show another structure of tips of teeth of a hybrid type stepping motor of the present invention.

### REFERENCE NUMERALS

1; stator core, 2; rotor core, 3; bearing, 4; permanent magnet, 5; shaft, 6; coil, 7; housing, 8; magnetic flux path, 9; steel plate, 10; main magnetic flux, 11; leak flux, 12; slits, 13; slot

### DETAILED DESCRIPTION OF PREFERRED EMBODIMENTS

In the following an embodiment of the present invention will be explained.

FIG. 1 shows structures of the most general, inner rotation type and two-phase hybrid type stepping motor whose basic step angle is 1.8 degrees. FIG. 1(a) shows a partially broken-away, perspective view and FIG. 1(b) shows a cross sectional view along the line A-O-A in FIG. 1(a). In the hybrid type stepping motor the stator and rotor are made of laminated steel plates. A minimum gap between the rotor and stator was as small as 30 to 50 μm, which is a value of the stepping motor capable of being produced. In FIG. 1(a), \textcircled{1}, \textcircled{2}, \textcircled{3}, \textcircled{4}, \textcircled{5}, \textcircled{6}, \textcircled{7} and \textcircled{8} designate the first pole, second pole, third pole, fourth pole, fifth pole, sixth pole, seventh pole and eighth pole, respectively.

The stator is provided with eight poles, which are arranged with a pitch of 45 degrees, each stator pole being provided with six small teeth with a pitch of 7.2 degrees, which are distributed to left and right from the center. On the other hand, the rotor is provided with a rotor core having 50 small teeth in the outer periphery thereof, wherein magnets that are magnetized in an axial direction. The small teeth of the upper and lower rotor core are assembled in such a relation that the phases of the rotor cores are displaced by 180 degrees.

The magnets are made of rare earth metal magnets such as samarium-cobalt alloy, neodymium-iron-boron, alnico magnet, ferrite magnets, etc. The shaft is made of non-magnetic material.

The winding is not shown in the drawings, but an A phase coil is wound around the first pole, third pole, fifth pole and seventh poles so that the winding direction around the third and seventh poles are opposite to those around the first and fifth poles. In the same way, a B phase coil is wound around the second, fourth, sixth and eighth poles.

In the structures shown in FIG. 1, when the small teeth at the N pole side of the stator core is opposed to the small teeth of the third and seventh poles of the stator in a relation in 1 to 1, the small teeth at the S pole side of the rotor core are opposite to the small teeth of the first and fifth poles in relation in 1 to 1.

The small teeth of the second and sixth poles are displaced by ½ pitch in anti-clockwise direction with respect to the rotor core small teeth pole of N pole side, the fourth and eighth pole small teeth pole are displaced by ½ pitch with respect to the rotor core small teeth pole of the N pole side and displaced by ½ pitch in an anti-clockwise direction with respect to the rotor core of the N pole side.

Accordingly, magnetic flux that flew out from the N pole side of the magnets passes between the third pole and the seventh pole, and enters the first pole and the fifth pole to arrive at the rotor core of the S pole side, while there is a twisting in an axial direction along the peripheral portion of the yoke.

In addition, at the second, fourth, sixth and eighth poles there are flux flows in the axial direction from the N pole side rotor core to the S pole side rotor core.

The above complicated flows of magnetic flux form distribution of magnetic flux density with different intensities and different directions at the small teeth pole of every pole. Torque proportional to the sum of the values squared of the magnetic flux in tangential components works on the rotor, and the rotor stops at a position where the total becomes zero.

Although the number of phases of winding is 2 phases in general, it is known that an increase in the number of phases generates good characteristics. However, since the increase in the number of phases generally results in complicated structure of the stator and driving circuits, 5 phases may be the limit from the practical point of view.

The basic step angle θs of a hybrid type stepping motor is expressed by the following equation wherein m is the number of phases and N is the number of small teeth of the rotor.

θs=π/(m·Nr) (equation 1)

It is understood from the equation that as the number of the small teeth Nr increases, a high resolving power is obtained. However, the number of the small teeth Nr has been mainly 15 from the viewpoint of machining limit. The machining limit is said that the minimum width capable of being machined is 80% of a thickness of magnetic material plate such as silicon steel plate, which is machined by punching. In general, since 0.5 mm thick steel plate has been mainly used, the minimum width is 0.4 mm. If a high-grade electromagnetic plate, which has a thickness of 0.35 mm, were employed, the machining limit is 0.28 mm. If the machining limit is decided, the number of teeth is decided depending on a gap diameter.

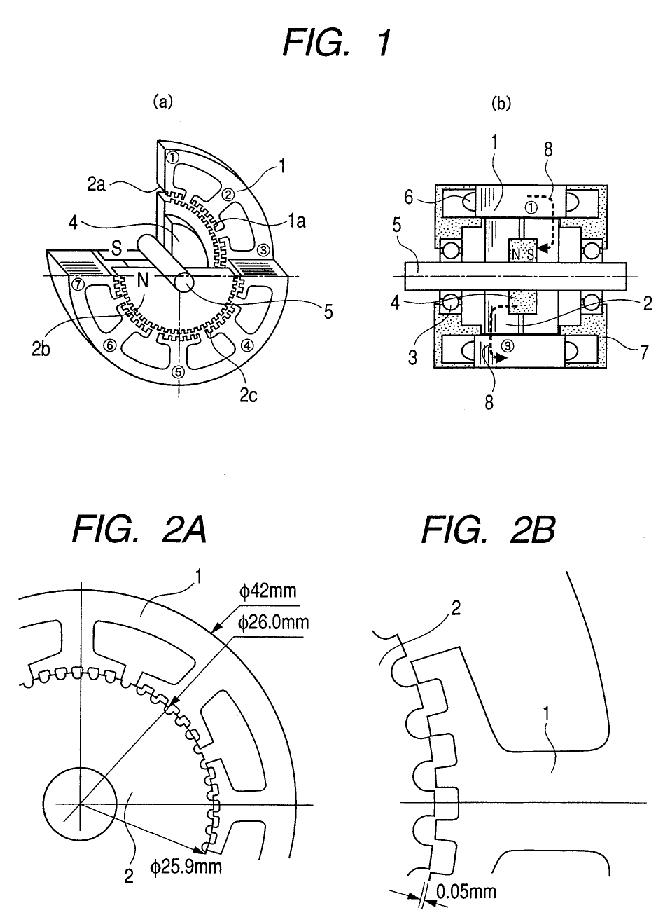

FIG. 2 A shows a detailed iron core structure of a hybrid type stepping motor according to an embodiment of the present invention. The hybrid type stepping motor of this embodiment is an inner rotating type. The number of the small teeth of the rotor core is 50, which are disposed with a pitch of 7.2 degrees. The outer diameter is 25.9 mm. The stator core 1 has six small teeth at the tips opposed to eight salient poles of the rotor. The outer diameter of the core is 42 mm, a width of the salient pole body portion around which coil is wound is 3 mm, and an inner diameter of the stator is 26 mm. A gap size between the rotor and the stator is 0.05 mm.

As is apparent from FIG. 2B, which is an enlarged view of the small teeth portion, a gap size is as small as about 1/10 the width of the small teeth. In a conventional method of manufacturing the hybrid type stepping motor, the stator core is fabricated by laminating punched steel plates with a smaller inner diameter than a desired size, followed by horning to finish the desired gap size. The designed inner diameter size of the stator shown in FIGS. 2A, 2B was 26.00 mm, but the size just after punching was 25.95 mm, which is smaller by 20 to 30 μm than the designed size. A portion of 20 to 30 μm is a polishing or finishing margin.

Similarly, the outer diameter size of the rotor is punched out with a larger size than the designed size and punched steel plates are laminated, followed by horning to finish the laminated steel plates. In the rotor core shown in FIGS. 2A, 2B, the steel plates were punched out with an outer diameter size of 25.95 mm, for example, which has a finishing margin of about 20 μm, and the punched steel plates were laminated.

It is apparent from the above description that since the both of the rotor core and the stator core have the same size of 25.95 mm, it is impossible to punch out the stator core and the rotor core from the same area in one steel plate at one time. A clearance between a punch and die a press die, which is proportional to a thickness of steel plate, is necessary. For example, when steel plate having a thickness of 0.5 mm is punched, clearance is 10% or less of the thickness, i.e. 0.05 mm; it is almost impossible to make the clearance zero. In addition, since the press die and electromagnetic plate expand or shrink under conditions such as temperature, etc in the die punch system (press die), it is very difficult to stably mass-produce the rotor and stator cores with the above-mentioned sizes in light of the scattering of sizes in the production.

Based on the above description, the method of easily manufacturing cores of the rotor and stator of the hybrid type stepping motor utilizing the etching process of the present invention will be explained in the following.

The stator iron core and rotor iron core (referred to as iron core, when appropriate) are made of laminated steel plates; steel salient poles are formed by etching processing, preferably photo-etching processing. A thickness of the steel plate is 0.08 to 0.3 mm. Preferably, the whole stator iron core is subjected to etching processing in view of magnetic characteristics and production efficiency.

Regarding the rotor iron core, steel plates having a thickness of 0.08 to 0.30 mm are preferably subjected to etching from the view point of improvement of magnetic characteristics, as same as the stator iron core. That is, machining of the stator iron core or rotor iron core by punching destroys regular crystal arrangement in the steel plate, which increases hysteresis loss. On the other hand, etching treatment of the stator iron core or the rotor iron core prevents an increase in the hysteresis loss.

In the punching machining, when the steel plates to be machined are thin, deformation of the punched portions such as crash, etc becomes a big problem, which leads to an increase in hysteresis loss.

Further, figures that are capable of being machined by punching are limited to simple forms such as circles, straight lines, etc. The reason is that punching machining needs a die and that it is difficult to shape the die into a complicated curved contour. In polishing the die, it is difficult to polish the die having a complicated curved shape.

In mechanical machining such as punching, a thickness of the steel plate can be made thin in order to reduce the eddy current loss, which increases hysteresis loss, however.

Etching processing eliminates the above-mentioned problems. That is, the hysteresis loss and eddy current loss can be lowered by utilizing the etching processing. The hybrid type stepping motor is provided with high efficiency by etching processing. A typical etching method is a photo-etching processing.

Etching processing lowers hysteresis loss by preventing breakage of regular crystal arrangement in the steel plate and further greatly improves characteristics of a spindle motor by increasing machining precision.

Since the magnetic gap can be machined with high precision, characteristics and efficiency of the hybrid type stepping motor are improved by lowering torque pulsation or harmonic wave magnetic flux or by lowering magnetic resistance or magnetic flux leak.

In addition, because the rotor iron core can be machined into complicated curved shapes that result in improvement of characteristics or efficiency, improvement of the characteristics and efficiency is better than the rotor iron core produced by punching.

For example, the gap between the stator iron core and the rotor can be machined with high precision so that improvement of characteristics such as lowering of pulsating movement can be achieved as well as an increase in efficiency.

Examples will be explained in the following.

In the following embodiment a laminated iron core density of the iron core was 90.0 to 99.9%. Preferably, the laminated iron core density is 93.0 to 99.9%.

The laminated iron core density is defined as follows. The laminated iron core density (%)=a thickness of steel plate (mm)×the number of the steel plates÷a height of the iron core (mm)÷100

The laminated iron core density may be increased by mechanically compressing the laminated iron core. However, this method is not preferable because iron loss increases in this method. In this embodiment the laminated iron core density can be increased without using the specific step.

The increase in the laminated iron core density lowers magnetic flux density in the iron core and the iron loss of the hybrid type stepping motor can be lowered.

In this embodiment the laminated iron core density (%) is calculated when the height of the iron core being 5 to 100 mm in case of a thickness of steel plate being 0.08 to 0.3 mm, the number of the steel plates being 20 to 300, and a height of the iron core being 5 to 100 mm.

A composition of the steel plate comprises C in an amount of 0.001 to 0.060 wt %, Mn in an amount of 0.1 to 0.6 wt %, P in an amount of 0.03 wt % or less, S in an amount of 0.03 wt % or less, Cr in an amount of 0.1 wt % or less, Al in an amount of 0.8 wt % or less, Si in an amount of 0.5 to 7.0 wt %, Cu in an amount of 0.01 to 0.20 wt %, the balance being Fe and inevitable impurities. The inevitable impurities include gaseous substances such as oxygen, nitrogen, etc.

Preferably, the composition of the steel plate, so called electro-magnetic steel plate, which has crystal grains, comprises C in an amount of 0.002 to 0.020 wt %, Mn in an amount of 0.1 to 0.3 wt %, P in an amount of 0.02 wt % or less, S in an amount of 0.02 wt % or less, Cr in an amount of 0.05 wt % or less, Al in an amount of 0.5 wt % or less, Si in an amount of 0.8 to 6.5 wt %, Cu in an amount of 0.01 to 0.1 wt %, the balance being iron and impurities.

In deciding the composition of the steel plate, contents of Si and Al are important in order to lower the iron loss. When the ratio Al/Si is decided from the above point of view, a preferable ratio is 0.01 to 0.60, more preferably 0.01 to 0.20.

There are silicon steel plates for hybrid type stepping motors, one of which contains 0.8 to 2.0 wt % of Si and the other contains 4.4 to 6.5 wt % of Si. The material is selected in accordance with types of stepping motors.

It is possible to increase magnetic flux density of the silicon steel plate by lowering the content of silicon. The flux density in this embodiment can be controlled to 1.8 to 2.2 T.

When the content of Si is small, rolling machinability is improved thereby to make the thickness of the plate small, which leads to lowering of the iron loss. On the other hand, if a high content of Si is desired, Si may be added to the steel after rolling thereby to lower the iron loss.

Silicon may be homogeneously distributed in the thickness direction of the steel plate. A silicon content may be locally high or a silicon content in the surface region may be higher than the inner region.

The iron core may have insulating films between the adjoining steel plates, which has a thickness of 0.01 to 0.2 μm. The insulating films having a thickness of 0.1 to 0.2 μm, preferably 0.12 to 0.18 μm. An insulating film having a thickness of 0.01 to 0.05 μm, preferably 0.02 to 0.04 μm may be employed for the hybrid types stepping motors.

When the thickness of the films is 0.01 to 0.05 μm, the films should preferably be oxide films. Especially, oxides of iron series are suitable. It is possible to make the insulating films thin by making the steel plates thin.

The conventional electromagnetic steel plates may keep the insulating films with desired insulating properties even after punching, and at the same time the insulating films improve punching machinability. The insulating films may function as lubrication for punching, adhesion between the steel plates, heat resistance at annealing after punching and welding properties for assembling the iron core, in addition to the insulation. The thickness of the film is determined in light of the above functions. Thus, at least 0.3 μm was necessary for the films.

In the thin silicon steel plates of the present invention the thickness of the films should be made smaller. If the insulating films used in the conventional steel plates were used, a volume ratio of the insulating films in the whole laminated steel plates becomes large so that magnetic flux density may decrease.

Therefore, it is necessary to make the thickness of the insulating films thin as much as possible in the present invention.

In general, if the electromagnetic plate is thin, the insulating film should be thick. However, this embodiment differs from the above in that even if the electromagnetic plate is made thin, the insulating film should not be made thick. On the contrary, the insulating film and the electromagnetic plate can be made thin. Accordingly, the laminated iron core density can be increased.

Taking into consideration the status of dispersion of Si in the silicon steel plate and use conditions of the rotor, the thicknesses should be studied. When an operation zone of the maximum rotating speed is low and when Si contained in the steel plate is distributed in the direction of the thickness, the maximum rotating speed is generally several thousands to several ten thousands rpm. Thus, the steel plate having a higher Si content in the surface thereof is selected in accordance with applications.

There is a relationship between the rotating speed and the iron loss in which as the rotating speed increases, the iron loss may increase because of an increase in an alternative frequency of the magnetic flux. A hybrid type stepping motor with high rotating speed tends to have a higher iron loss than a hybrid type stepping motor with a lower rotating speed. In view of this point, the Si content of the Si steel plate should be decided.

Si may be added to the electromagnetic steel plate homogeneously by a melting method or added locally or partially in the surface by surface modification methods such as ion injection, CVD (chemical vapor deposition), etc.

The electromagnetic steel plate is used for iron cores having salient poles and yokes and a rotor iron core having a number of small teeth of a hybrid type stepping motor. A thickness of the electromagnetic plate is 0.08 to 0.30 mm and is capable of forming salient poles and yokes by etching.

An etching process of the electromagnetic steel plate is carried out as follows:

(1) Coating resist on the steel plate, (2) exposing a stator iron core pattern, (3) developing the pattern, (4) removing non-developed resist, (5) etching the steel plate with an etching solution, and (6) removing the remaining resist after etching.

Making the electromagnetic silicon steel plate thin, which is good for attaining low iron loss, has been considered difficult to realize it without drastically increasing production cost on an industrial scale, from the view points of bad rolling property of the silicon steel plate and bad punching machinability for forming the iron core. In general, when silicon steel plate is used as the electromagnetic steel plate for hybrid type stepping motors produced at low cost, silicon steel plate having a thickness of 0.05 mm and containing a small amount of silicon has been mainly used for a long time, but there has been no development of employing new iron core. However, in this embodiment, making the silicon steel plate thin and low iron loss were realized by etching processing without using punching machining and increasing a big cost on industrial scale.

In this embodiment, in order to realize the low iron loss, silicon steel plate was used, and controlling the silicon content, making the steel plate thin both for rolling property, etching process for forming the iron core, making low the iron loss of every steel plate for constituting the laminated iron core and insulating films formed between the silicon steel plates were taken into consideration.

In a punching process that uses a punching die, plastically deformed layers such as work hardening layer, burrs, die wear, etc are formed in the vicinity of sheared portions, and residual strain or residual stress remains. The residual stress generated at the time of punching destroys the regularity of molecular magnets, i.e. destroys magnetic segments, thereby to greatly increase the iron loss, which needs annealing treatment for eliminating the residual stress. The annealing heat treatment brings about an increase in a production cost of the iron core.

In this embodiment, since the iron core can be produced without punching process, the plastic deformation layer is hardly formed and almost no residual strain and residual stress are generated. Accordingly, damage of the arrangement status of crystal grains is not avoided thereby to prevent degradation of hysteresis characteristics.

The iron core is produced by laminating worked silicon steel plates. By suppressing generation of residual strain or residual stress in the embodiment, magnetic characteristics of the iron core are further improved.

Accordingly, the hybrid type stepping motor of the present embodiment realizes a low iron loss, high output and compact-light weight. The electromagnetic steel plates used in the hybrid type stepping motor hardly generate burr, etc at the edge portions thereof.

Since the burrs, one of plastic deformation, are protruded sharply in a direction towards a space from the flat face of the steel plate along the sheared face, they may break the insulating films formed on the surface of the plates thereby to destroy insulation between the laminated steel plates.

In laminating the damaged steel plates, since unnecessary gaps may be formed between the laminated steel plates by burrs, etc so that a density of the laminated iron core is lowered to thereby lower magnetic flux density. Reduction of the magnetic flux density prevents compact-light weighted hybrid type stepping motors.

Although after laminating steel plates, a method for bursting the burrs, etc by pressing the laminated steel plates in a thickness direction thereof may be employed to increase the density of the laminated iron core, the residual stress due to pressing and compression remains to increase the residual stress and increase the iron loss.

In addition, there is a problem of insulation breakdown due to the burrs, etc. Although post treatment such as horning, polishing, etc for removing the burrs has been employed, there is a drastic increase in a production cost and there are foreign matters (metal powder) produced by processing that remain in the laminated steel plates and that may clog gaps. Therefore, the post processing needs a cleaning step and inspection of foreign matters and lowers a yielding rate.

In the iron core of this embodiment, there is almost no burr, etc, and it is possible to increase density of the laminated iron core without the pressing or compressing process. There is no insulation breakdown, either. Accordingly, there is no iron loss.

In the silicon steel plates used as the electromagnetic steel plates, the iron loss is theoretically the smallest when the silicon content is 6.5 wt %. However, as the silicon content increases, the rolling workability or punching machinability become greatly worse. Accordingly, even if the iron loss is high, the silicon steel plates containing silicon in an amount of about 3 wt % have been mainly employed.

In the silicon steel plates explained in this embodiment, since the thickness of the plates can be made as thin as 0.3 mm or less, the iron loss is small even when the silicon content is 2.0 wt %.

Heretofore, in production of thin silicon steel plates of 0.3 mm thick or less, specific processes such as rolling and annealing, etc were necessary. The silicon steel plates of the present invention do not need such the specific processes so that the production cost thereof can be lowered. Regarding production of the iron core, since the punching process is not necessary, a further cost reduction is possible.

In addition to the silicon steel plates, which are the main material for the iron cores, amorphous material, which is used in a specific use and very expensive, has been known. The amorphous material is produced by rapidly quenching and solidifying molten metal, and ultra thin material having a thickness of 0.05 mm or less and a width of about 300 mm is produced, but it is said that the production of the amorphous material having larger thickness and larger width is impossible on an industrial scale.

Because the amorphous material is hard, brittle and excessively thin, punching of the amorphous material is impossible, and because of limitation of its chemical composition, it has low magnetic flux density. Thus, it cannot be a main material for the iron core.

The electromagnetic steel plates in this embodiment have crystal grains unlike the amorphous material. The electromagnetic steel plates realized simultaneously making the plates thin, which is effective for lowering the iron loss, reduction in strain, increase in a dimension accuracy effective for compact-light weight, and an increase in laminated iron core density.

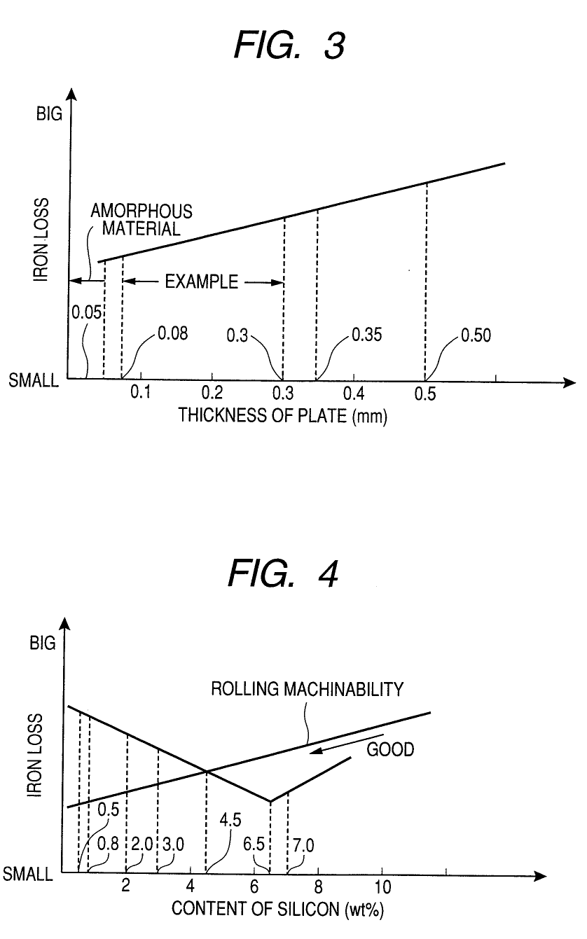

According to this embodiment, it is possible to provide an iron core having a low iron loss, high output and compact-light weight. FIG. 3 shows a relationship between a thickness of the electromagnetic steel plate and iron loss. It is understood from FIG. 3 that the lager the thickness of the steel plate, the larger the iron loss generates. A thickness of a widely used silicon steel plate is 0.5 mm and 0.35 mm in view of rolling property and punching property. The silicon steel plates of two thicknesses, which are used in production of iron cores, need rolling and annealing for reducing the iron loss.

Further, in order to make the thickness of the steel plate smaller, repetition of rolling and annealing is necessary, the number of repetition being depending on structures and sizes of the iron cores. Accordingly, the conventional silicon steel plates need rolling and annealing for further thinning of the steel plate, which increases production cost.

The iron core explained in this embodiment can be produced at low production cost and eliminate problems in production, which makes it possible to conduct mass production on an industrial scale. In this embodiment, the silicon steel plate had a thickness of 0.08 to 0.30 mm. Preferably, the silicon steel plate should have a thickness of 0.1 to 0.2 mm, and patterning of the iron core is carried out by etching.

FIG. 3 shows the thickness in the area of the amorphous material. Since the amorphous material is produced by rapidly quenching and solidifying molten metal (alloy) to produce foil, the process is suitable for producing an ultra-thin plate. In case where steel plate thicker than the above foil, rapid quenching and solidification are difficult. The maximum width of the strip or plate is about 300 mm, which is known as a process of high production cost.

Regarding the magnetic characteristics, the amorphous material has such drawbacks that magnetic flux density is low, whilst the iron loss is small. This is because the chemical composition (alloying composition) is limited in order for quenching and solidifying the molten metal. In this embodiment, the silicon steel plate having crystal grains, unlike the amorphous foil or strip, is used.

In the following, a typical method of producing the silicon steel plate is explained.

Alloying elements for the electromagnetic plate were prepared. Prepared was a material consisting of C in an amount of 0.005 wt %, Mn in an amount of 0.2 wt %, P in an amount of 0.02 wt %, S in an amount of 0.02 wt %, Cr in an amount of 0.03 wt %, Al in an amount of 0.03 wt %, Si in an amount of 2.0 wt %, Cu in an amount of 0.01 wt %, the balance being Fe and inevitable impurities. The steel plate material was subjected to continuous casting, hot rolling, continuous annealing, acid-cleaning, cold rolling and continuous annealing thereby to produce silicon steel plate having a width of 50 to 200 cm, particularly 50 cm, and a thickness of 0.2 mm. The produced steel plate may be coated with silicon of 4.5 to 6.5 wt % per the plate so as to reduce the iron loss. Thereafter, an organic insulating coating film having a thickness of 1 m may be formed on the plate. If necessary, an oxide film having a thickness of 0.01 to 0.06 μm can be formed without coating the organic insulating film. The coating step of the insulating film is preferably applied, during the production of the steel plate, after the etching step. The steel plate is formed into any of flat plate, coiled state or rolled state.

In the following a typical method of producing the iron core is explained.

After a pre-treatment of the silicon steel plate, resist was coated. A pattern of a stator iron core was exposed and developed with developing light by means of a mask. Undeveloped resist was removed. Thereafter, the plate was subjected to etching with an etching solution.

After the etching, the remaining resist was removed to thereby form silicon steel plate having a desired shape of the stator iron cores. A photo-etching process is suitable for the above method. Another etching method using a precise metal mask for machining fine holes may be useful.

A plurality of the resulting silicon steel plates each having a shape of the iron core was laminated and fastened by welding, etc to produce the iron core. In welding, a welding method with small thermal volume such as fiber laser is preferably employed.

By producing the salient poles using the etching process, it is possible to produce a stator iron core having a desired shape with remarkably high machining precision, for example, ±10 μm or less, preferably ±5 μm or less.

If the error is expressed by circularity, an inner diameter and outer diameter of the stator iron core and of the rotor iron core of the hybrid type stepping motor had circularities of 10 μm or less, preferably 5 μm or less, respectively. In the above, the circularity is an amount of deviation of the circle portion from the geometric circle. That is, the circularity is a difference between radii of two geometrically concentric circles that sandwich an area between the circular portions becomes the minimum.

FIG. 4 shows a relationship between a silicon content in the silicon steel plate and iron loss.

As shown in FIG. 4, when the silicon content is 6.5 wt %, the iron loss is smallest. However, if such a large amount silicon is contained, rolling of the steel plate is difficult so that a steel plate having a desired thickness is difficult to be produced. The higher the silicon content in the steel plate, the worse the rolling processability becomes.

From the above background, in considering balance between the iron loss and rolling processability, silicon steel plate containing about 3 wt % has been used. Accordingly, by making the silicon steel plate thin, the iron loss is lowered so as to lessen influence of silicon content on the iron loss. As a result, the silicon steel plate explained in this embodiment has better rolling processability and has larger freedom on selection of silicon content that has a great influence on the iron loss by making the steel plate thinner. Accordingly, silicon content of the silicon steel plate should preferably be 0.6 to 7.0 wt %. If desired, silicon steel plates each containing 0.8 to 2.0 wt % and 4.5 to 6.5 wt % can be combined based on specifications or use of the stepping motors.

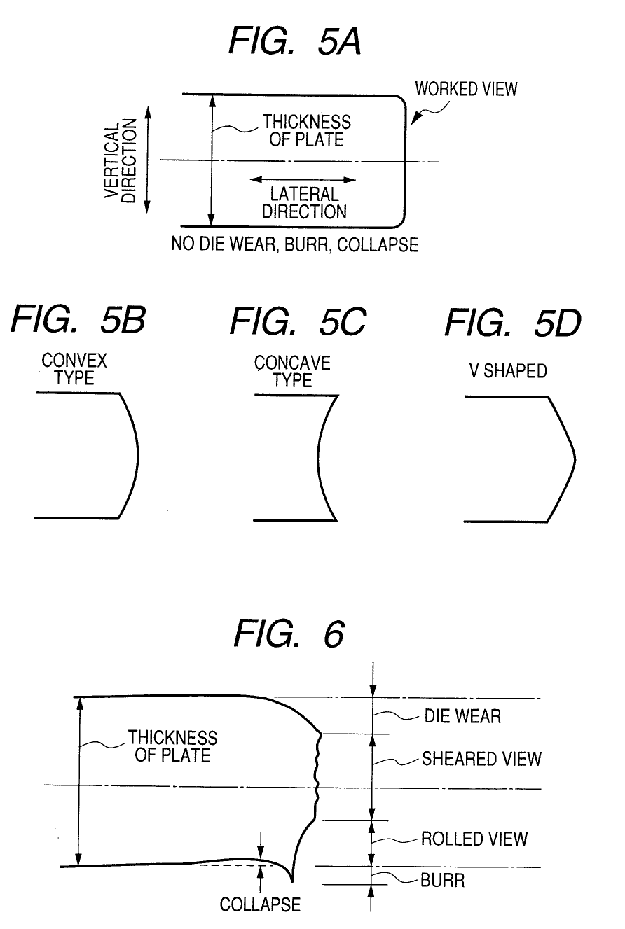

FIGS. 5A to 5D show different sectional contours of end portions of silicon steel plates.

By etching processing the silicon steel plates, there are no plastic deformation layers such as burrs, etc in the vicinity of the etched sectional portion as shown in FIG. 5A. The etched face can be formed in a substantially vertical direction with respect to the horizontal face of the silicon steel plate. In advanced photo-etching processes, the contours of the etched portions can be controlled as shown in FIGS. 5B to 5D. That is, desired tapers or uneven faces with respect to the direction of the thickness of the plates can be formed in the faces of etched portions of the silicon steel plates.

As has been explained, the etched silicon steel plates have substantially no residual stress and no plastic deformation layers. An amount of the plastic deformation with respect to the direction of the thickness of the plates is almost zero. Further, an amount of plastic deformation in the vicinity of the etched portions is almost zero, too. In addition, it is possible to control the cross sectional contours of the etched portions so that cross sectional cut faces by etching have no residual stress and no plastic deformation.

By utilizing the etching process, it is possible to apply the silicon steel plates to the iron core under such conditions that the fine crystal structure, mechanical properties and surface portions of the steel plates are optimized. It is also possible to realize optimum magnetic characteristics of the iron core in considering anisotropy of the crystal structure of the steel plates.

FIG. 6 shows a typical cross sectional contour of a punched plate.

By punching the silicon steel plate, the portions in the vicinity of the punched section are heavily deformed to thereby form burrs, die wear and collapse in the order of 10 to 100 μm.

Regarding the size precision of the silicon steel plate in a direction along the horizontal plane of the silicon steel plate, it is restricted by a precision of the punching die. Normally, since the silicon steel plate is sheared with a gap of 5% with respect to a thickness of the plate, the precision of the steel plate in a lateral direction decreases. Further, a precision of the die decreases with time as the die wears at the time of mass-production. The thinned silicon steel plate is hard to be punched.

The present invention that employs the etching process eliminates the above-mentioned various problems to avoid reduction in precision with time.

In exposing the pattern of the stator core using a desired mask pattern, it is preferable to make marks indicating a direction of rolling of the steel plate or positioning holes in the electromagnetic plate.

In laminating the electromagnetic plates, it is important to normalize the rolling directions of the plates to improve characteristics of the hybrid type stepping motor. For example, positions of the marks or standard holes are disposed differently for the plates in laminating the plates thereby to improve characteristics of the hybrid type stepping motor.

FIG. 7 shows a pattern of iron cores each having a diameter of 42 mm formed in a steel plate of 450 mm×750 mm. There are 9 rows of iron cores in an altitude direction and 15 rows of iron cores in the lateral direction. Since the accuracy of the etching process is very high, it is possible to form the stator and rotor in a concentric relation within the same area of the steel plate. In case of punching, it is impossible to form the stator and rotor in a concentric relation within the same area of the steel plate because of the necessity of the die clearance mentioned above between the stator iron core and the rotor iron core.

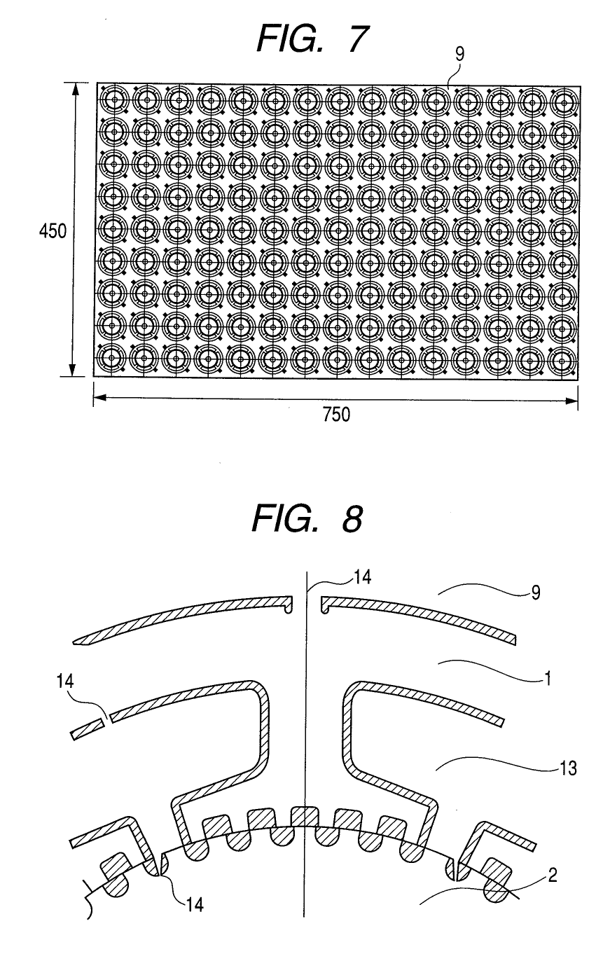

Dissolving the hatched portions with an etching solution as shown in FIG. 8 forms the iron cores. The removed portions should be as small as possible in view of post treatment of the discharged drains. Therefore, the gap portions are dissolved, and the stator outer diameter and stator slots are formed by dissolving with thin lines along with profiles. If the gap portions and outer peripheries of the iron cores are completely dissolved, the iron cores are separated from the plate. Thus, the iron cores are connected with connecting members at positions where magnetic circuits are not advertently affected thereby to hold the iron cores on the plate until separation thereof from the steel plate.

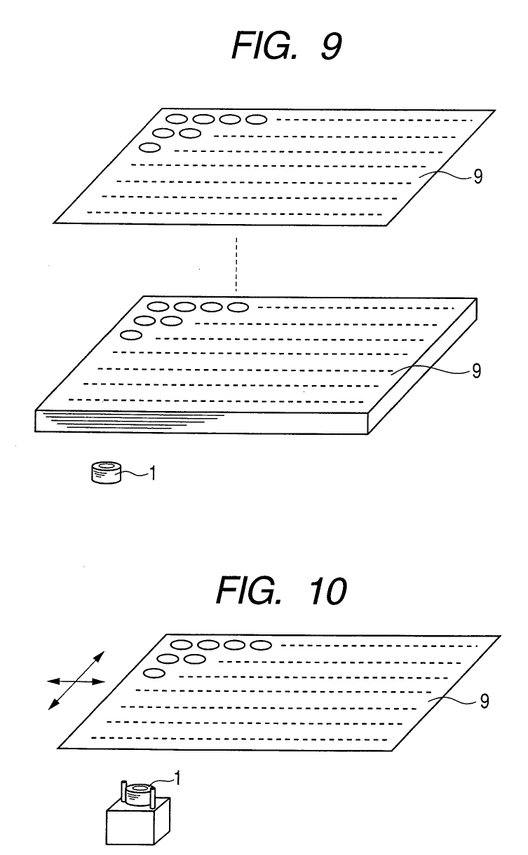

FIGS. 9 and 10 show methods of laminating steel plates. FIG. 9 shows a method in which steel plates that are subjected to etching are laminated as they are. Each of the steel plates is coated with an insulating coating having a thickness of about 5 μm. In order to coat the thin insulating film there are homogeneous coating methods such as roll coating or a mist spraying method. After the coating is coated by the above method, it is preferable to press the plates in a lamination direction to thereby bond the plates to each other. According to the above methods, the above mentioned laminated iron core is obtained.

The laminated iron cores with a desired size are separated from the laminated plates by pressing the core portions with a simple tool. Since the stator and rotor iron cores connected with a very thin connecting member 14 as shown in FIG. 8, the cores are easily separated from each other as if they were plastic models. The connecting members 14 are formed at positions where magnetic flux never passes in magnetic circuits, e.g. positions extending from the outer diameter to the inner diameter, intermediate positions among winding slots, roots of the small teeth, etc.

After holding the whole (stator cores plus rotor cores), the rotor portions are separated with the tool at first; then after unnecessary portions such as slot portions are removed, the stator cores are separated to thereby produce the laminated stator cores and laminated rotor cores. Since they are worked at a high precision by etching, a post treatment such as horning is not necessary.

Although there may remain very small projections at the connecting members, and since they are located at position where there is no magnetic problem, the process for removing them is not necessary.

In the case where the amount of production is large, the method shown in FIG. 9 is suitable. However, when the amount of production is small, the method shown in FIG. 10 may be more suitable. For example, the etched plates are provided with positioning for the tool for laminating the stator cores and rotor cores, the necessary portions being laminated by bonding. Since the bonding layers should be thin as much as possible, the bonding layers are formed by a coating method using such as mist spraying or a dispenser. The bonded plates are laminated by pressing them in the direction of its thickness. Since this method enables iron cores having different contours to be laminated, cores in a three dimensional structure are produced.

The hybrid type stepping motor whose thin electromagnetic steel plates are processed by the etching process exhibits a small cogging torque because of high precision of the iron cores and small iron loss so that the hybrid type stepping motor with high precision and high efficiency is provided.

Office automation equipments such as printers copiers and industrial equipments such as robots, which employ the hybrid type stepping motors of the present invention increase positioning accuracy because of a sufficiently small cogging torque, and increase an operating speed because of the small iron loss which leads to improvement in an output at high speed side.

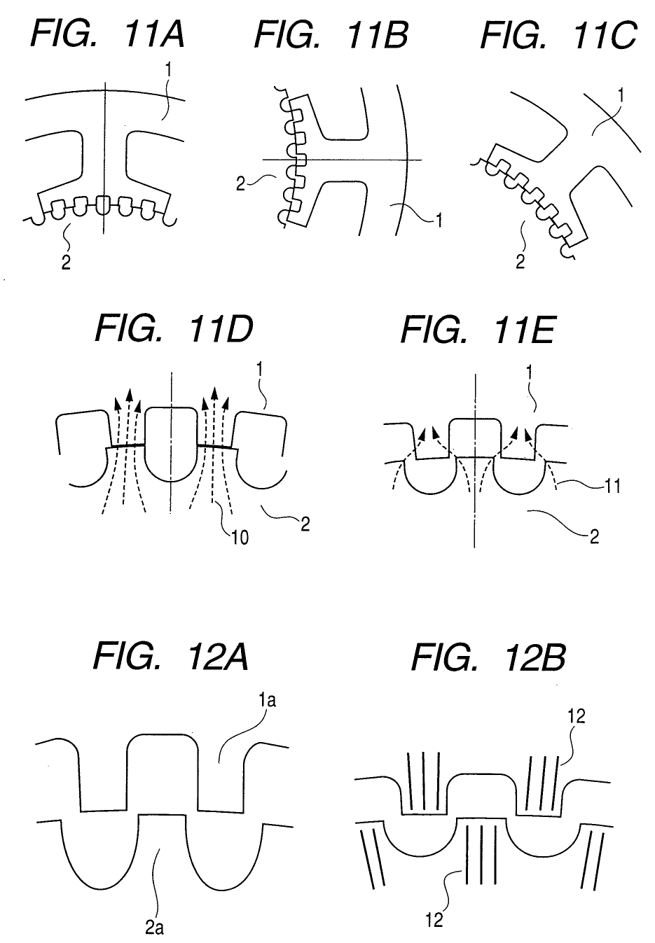

FIGS. 11A to 11E show structures of rotor iron cores and stator iron cores of the hybrid type stepping motor of the present invention. The same reference numerals as in FIG. 1 represent the same elements. The whole structure is the same as in FIG. 1.

The hybrid type stepping motor has portions shown in FIG. 11A where the small teeth pole of the stator iron core and small teeth pole of the rotor iron core are opposed to each other in the same plane, portions shown in FIG. 11B where the teeth of the stator iron core and rotor iron core are not opposed to each other, and portions shown in FIG. 11C are intermediately opposed. In the case where portions are magnetically opposed, magnetic flux tends to flow, while being not opposed, magnetic flux hardly flows so that the difference between the two cases becomes interlinkage magnetic flux to thereby drive the motor.

Ideally, it is the best that magnetic flux does not flow when the teeth are not opposed, but leak magnetic flux flows as shown in FIG. 11E. In designing the motor, the teeth structure of the motor is selected so that the difference in magnetic flux flow becomes large as much as possible.

When a magnet whose energy product is large is employed, supply of magnetic flux increases, but magnetic flux density at the opposed portions is saturated to increase leakage of magnetic flux at non-opposed portions. As a result, the difference becomes small.

On the other hand, when a lower grade magnet is used, the magnetic flux density at the opposed portions decreases. As a result, the difference becomes small. That is, in the hybrid type stepping motor of the present invention, the intensity of the magnet that generates the maximum interlinkage magnetic flux is automatically decided based on the structure of teeth of the stator iron core, rotor iron core and a thickness of lamination. By utilizing the etched steel plate according to the present invention, it is possible to increase an output of the hybrid type stepping motor. In the etching process, a high precision machining can be done without degrading magnetic characteristics of the steel plate.

As shown in FIGS. 12A and 12B, it is possible to form a tooth structure wherein the magnetic flux leakage between the adjoining teeth is reduced. In FIGS. 12A and 12B, there are shown teeth of an elongate structure. For example, a structure of teeth is made such that a depth of grooves is 1.5 to 3 times a width of the small teeth of the stator and rotor.

In the conventional teeth manufactured by press-machining (punching), and post-treatment such as horning, etc, the narrow teeth shown in FIG. 12A have insufficient rigidity so that they are deformed and a desired precision was not obtained. On the other hand, the iron core using the etched steel plates does not need post-treatment. As a result, even the narrow teeth can be machined with a high precision.

FIG. 12B shows an example wherein slits 12 are formed in a perpendicular direction at the tip of teeth. The tips of the teeth having a width of about 0.5 to 1 mm of the hybrid type stepping motor were provided with a plurality of very narrow slits (gaps). The width of the slits was about 50 μm or less. Since the slits control flow of magnetic flux in the circumferential direction, the permeability of magnetic flux at the opposed portions is maintained and permeability of magnetic flux is decreased because of high magnetic resistance at the non-opposed portions. As a result, a quantity of magnetic flux that has an interlinkage to the coil is remarkably increased.

Since the above structure has a function to absorb vibration generating at the tips of the teeth as a reaction force of torque, resonance vibration is suppressed as a damper to realize a high speed hybrid stepping motor.

According to the above structure, reduction of the iron loss by thinning the steel plate, it is possible to achieve the prevention of the iron loss that was caused by punching, and reduction of cogging torque by making high precision.

The hybrid type stepping motors of the present invention can be applied to office automation equipments and industrial equipments to provide various equipments with high efficiency, high speed driving performance and high precision positioning performance.

What is claimed is:

1. A stepping motor comprising:
a stator iron core with a plurality of salient poles each having a small tooth at the tip thereof and a stator coil disposed between the salient poles;
a rotor core with a plurality of small teeth in the faces opposite to the stator; and
permanent magnets sandwiched by the rotor iron cores in an axial direction,
wherein the stator iron core and the rotor core are made of laminated steel plates, the salient poles of the steel plates and small teeth are shaped in a form that the edge portions of the salient poles and small teeth are substantially free from plastic deformation, and a thickness of the steel plates is 0.05 to 0.30 mm.

2. The stepping motor according to claim 1, wherein the steel plates consists essentially of 0.001 to 0.060% by weight of C, 0.1 to 0.6% by weight of Mn, 0.03% by weight or less of P, 0.03% by weight or less of S, 0.1% by weight or less of Cr, 0.8% by weight or less of Al, 0.5 to 7.0% by weight of Si, 0.01 to 0.20% by weight of Cu, the balance being Fe and inevitable impurities.

3. The stepping motor according to claim 1, wherein the steel plates are made of silicon steel plates.

4. The stepping motor according to claim 1, wherein the steel plates contain crystal grains therein.

5. The stepping motor according to claim 1, wherein an insulation film having a thickness of 0.01 to 0.2 μm is formed between laminated steel plates of the stator iron core and rotor core.

6. The stepping motor according to claim 1, wherein an insulation film having a thickness of 0.1 to 0.2 μm is formed between laminated steel plates of the stator iron core and rotor core.

7. The stepping motor according to claim 1, wherein the insulating film is made of organic material, inorganic material and a combination thereof.

8. The stepping motor according to claim 1, wherein an insulation film having a thickness of 0.01 to 0.05 μm is formed between laminated steel plates of the stator iron core and rotor core.

9. The stepping motor according to claim 1, wherein the insulating film is an oxide film.

10. The stepping motor according to claim 3, wherein a content of Si in the silicon steel plate is 0.8 to 2.0% by weight.

11. The stepping motor according to claim 3, wherein a content of Si in the silicon steel plate is 4.5 to 6.5% by weight.

12. The stepping motor according to claim 3, wherein a content of Si in the surface portion of each of the silicon steel plates is higher than that of an inner portion of each of the silicon steel plates.

13. The stepping motor according to claim 1, wherein the opposite faces of the stator iron core and the rotor core are worked by etching so that the opposed faces are in parallel with each other.

14. The stepping motor according to claim 1, wherein the stator iron core and the rotor core are laminated in an axial direction by means of an adhesive, the opposed surfaces that are worked by etching being utilized as gap faces.

15. The stepping motor according to claim 1, wherein the small teeth of the stator and rotor have slits.

16. The stepping motor according to claim 15, wherein each of the slits has a width of 0.05 mm or less in the normal line with respect to the rotating shaft.

17. The stepping motor according to claim 1, wherein a laminated iron core density (%) is 90.0 to 99.9, the density being defined as follows.
density (%)=a thickness of the steel plate (mm)×the number of steel plates×100

18. A stepping motor comprising:
stator iron core with a plurality of salient poles each having a small tooth at the tip of each of the salient poles;
a stator having a plurality of stator coils each being disposed between the salient poles; and
a plurality of permanent magnets each being sandwiched by the rotor iron cores having a plurality of small teeth in opposite faces to the stator iron core in an axial direction,
wherein the small teeth of the stator and the rotor have slits.

19. The stepping motor according to claim 18, wherein the slits are aligned in the normal line with respect to the opposite faces.

20. A stepping motor comprising:
stator iron core with a plurality of salient poles each having a small tooth at the tip of each of the salient poles;
a stator having a plurality of stator coils each being disposed between the salient poles; and
a plurality of permanent magnets each being sandwiched by the rotor iron cores having a plurality of small teeth in opposite faces to the stator iron core in an axial direction,
wherein the small teeth of the stator and the rotor have a contour such that a depth of grooves is longer than a width of the small teeth.

21. A method of manufacturing a stepping motor comprising: patterning stator iron cores and rotor cores in concentric relation in a steel plate having a desired thickness;
etching out unnecessary portions other than the stator iron cores and the rotor iron cores with connecting members connecting the stator iron cores and the rotor iron cores in the steel plate;
laminating a desired number of the etched steel plates.

22. The method of manufacturing a stepping motor according to claim 21, wherein the etching process further comprises;
coating a photo-resist on the surface of the steel plates;
exposing the photo-resist in a form of a plurality of the stator iron cores and rotor iron cores in concentric relation in the steel plate;
developing the exposed resist by removing the photo-resist being not exposed;
etching the steel plate to form the stator iron cores and rotor iron cores; and
removing the exposed resist from the stator iron core.

23. A steel plate for manufacturing a stepping motor comprising:
a plurality of stator iron cores with a plurality of salient poles each having a small tooth at the tip of each of the salient poles;
a plurality of rotor iron cores, in concentric relation with the stator iron cores having a plurality of small teeth in opposite faces to the stator iron core in an axial direction;
a plurality of stator coils each being disposed between the salient poles;
a plurality of permanent magnets each being sandwiched between the stator iron cores and rotor iron cores; and
insulating films formed between the adjoining steel plates to electrically insulate them;
wherein sectional contours of the stator iron core and the rotor iron cores and in the vicinity thereof are substantially smooth and substantially free from plastic deformation.
